(19) United States
(12) Patent Application Publication
(10) Pub. No.: US 2012/0017490 A1
(43) Pub. Date: Jan. 26, 2012

(54) Degradable diving sinker for sports fishing

(76) Inventor: Jeffrey John Wessner, Pt. Reyes Station, CA (US)

(21) Appl. No.: 12/804,496

(22) Filed: Jul. 23, 2010

(51) Int. Cl. A01K 95/02

(52) U.S. Cl. 43/43.12

(57) ABSTRACT

The present invention has an advantage over the currently used toxic lead sinkers because when lost or intentionally jettisoned the sinker degrades leaving no toxic residue to pollute the fishing grounds. This invention is a hybrid fishing sinker shaped like a diving plane with sufficient weight so as to reach appropriate depths. The sinker is composed of a compound of steel granules and Portland cement. During manufacturing, this compound is cast into a mold and solidifies. When fishing the diving quality of the shape compensates for the reduced weight of the steel and cement compound which are not as dense as the currently employed lead metal now being restricted due to environmental concerns.

### CROSS REFERENCE TO RELATED APPLICATIONS

N/A

### STATEMENT REGARDING FEDERALLY SPONSORED RESEARCH OR DEVELOPMENT

N/A

### REFERENCE TO SEQUENCE LISTING

N/A

### BACKGROUND OF INVENTION

The field of this invention relates to sinkers for use in deep water sports fishing which are intentionally jettisoned when the target fish strikes the bait. Increasingly, environmental concerns surround the usage of common sinker materials.

### BRIEF SUMMARY OF THE INVENTION

An improved fishing sinker having an inclined diving plane and sufficient weight, heavy enough to reach depths appropriate to catch fish by hook. The sinker is composed of a compound of steel granules and Portland cement and colored to appear as a biomass. Turned into a slurry (by adding sufficient water) and cast into a mold, the mixture of steel granules and cement, solidify forming a shape that makes a diving action when pulled through the water.

The diving characteristic compensates for the reduced specific gravity as steel and cement are not as dense as the normal employed lead.

An advantage of the degradable diving sinker over the commonly used sinkers is obtained by using a steel and cement formulation which, when exposed to fresh or salt water, will decompose over time leaving no environment polluting residue.

### BRIEF DESCRIPTION OF THE DRAWINGS

Having described the invention in general terms, reference will now be made to the accompanying drawings:

FIG. 1 is a bulbous solid ballast that is attached below and slightly forward of the dive plane.

FIGS. 2 and 3 are of the diving plane which is scooped taking the shape similar to a parabola if viewed from the front.

FIG. 4 is a groove that acts as the cradle for a common release spring mechanism. The groove protrudes upward from the base of the plane. The topmost portion is shaped like a pipe that is half open. This part of the invention is where the standard cylindrical-shaped common release spring mechanism will rest as the sinker dives to the desired depth.

FIG. 5 is the sinker attachment ring. The ring is located along the groove described in FIG. 4, above. The ring is positioned to keep the common release spring mechanism in place while the whole assembly is diving.

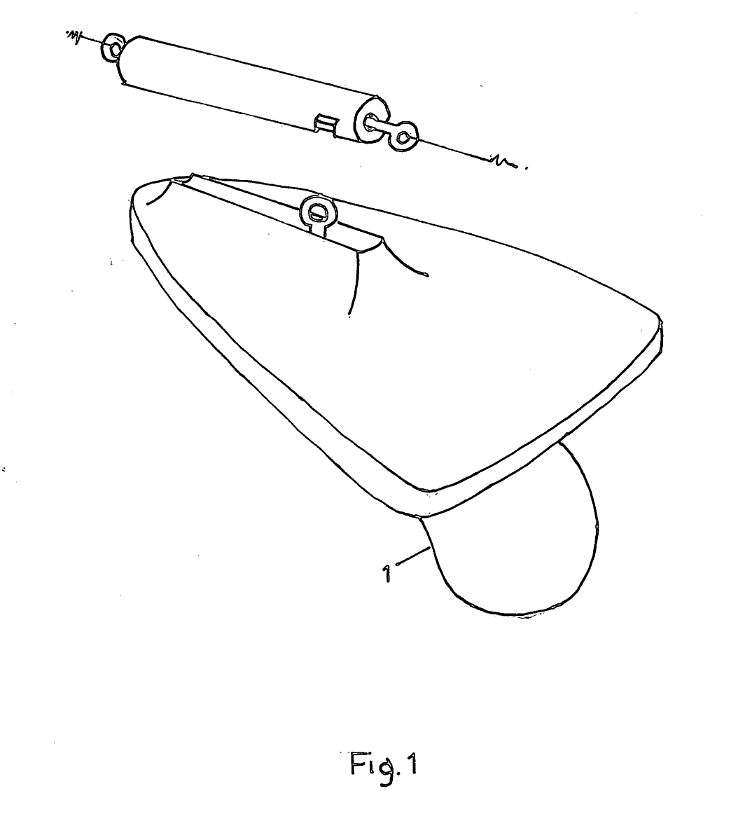

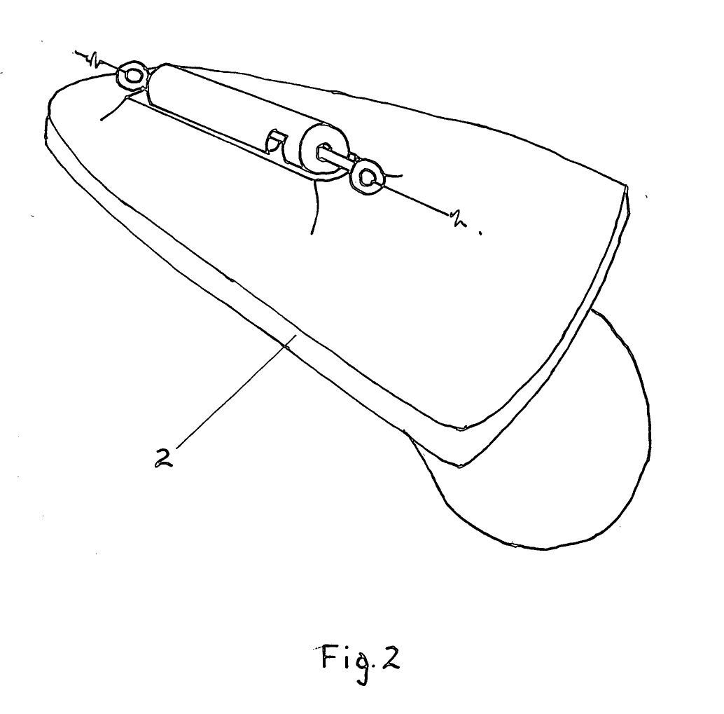

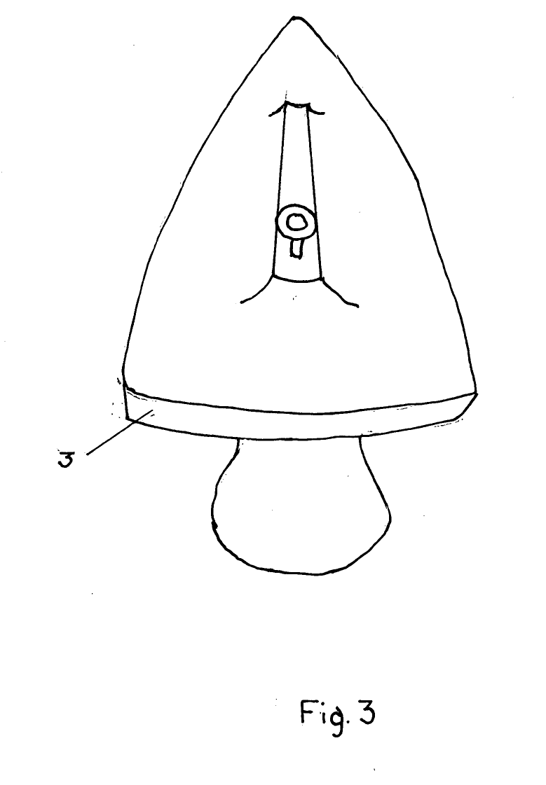

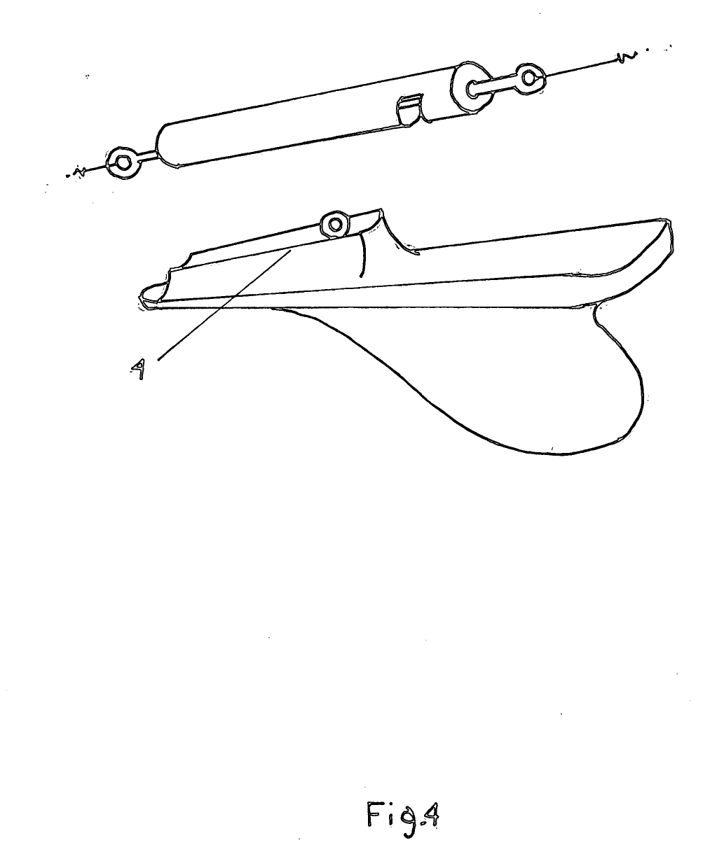

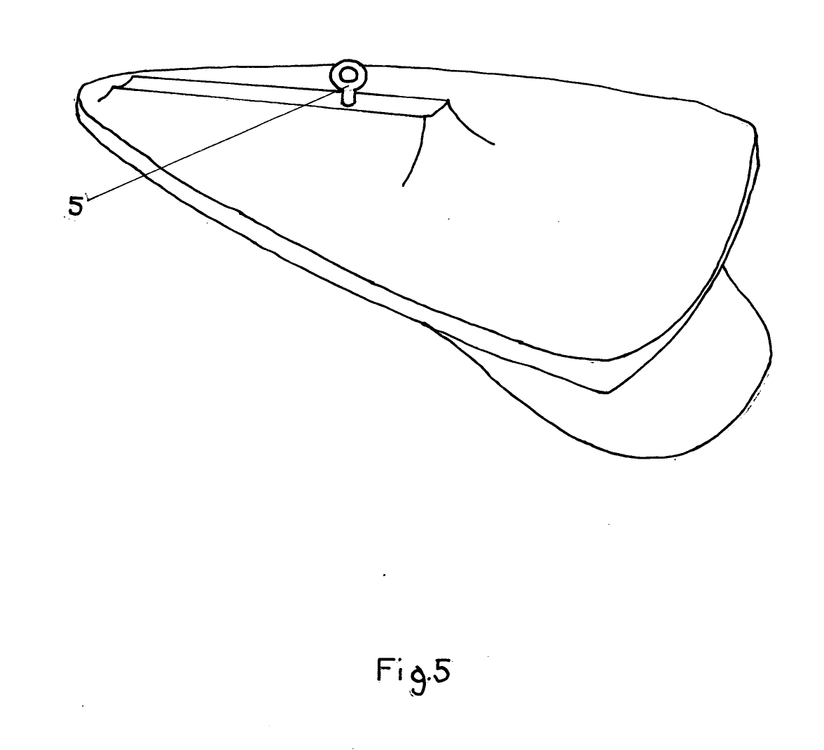

### DETAILED DESCRIPTION OF THE INVENTION

A fishing sinker device comprised of a weighty dive angle plane that is molded by casting a slurry of Portland cement mixed with an aggregate of steel granules. A projecting ballast segment hangs below the scoop shaped dive plane which is integrally cast with the said planing surface to add weight and additional stability which keeps the plane pressed to the water in proper position for maximum depth which is adjusted by the amount of line the fisherperson pays out.

In addition, a grooved projection rising from the planing surface creates a cradle with a precise angle which holds a common sinker release spring mechanism which works with the natural balance of the diving sinker to maintain proper angle of attack of the diving sinker in water.

Also, the castable slurry solidifies into a part that is degradable by water and exposure to fresh or salt water causing the steel aggregate to expand with the rusting and spalling process. This expansion makes the concrete matrix chip apart into a very minute degradable pieces after the sinker is jettisoned.

A ring for connecting a common release mechanism is also precisely positioned and attached to the grooved ramp. Once the bait is taken by the fish, the release spring mechanism detaches from the ring and releases the sinker to the bottom of the sea.

In ancient times as well as sometimes today, fishing sinkers consist of materials found ordinarily in the natural environment such as stones, rocks, or bone. Today the most prevalent sinkers are made of lead since the material is inexpensive to produce and molds into a large variety of shapes for specific fishing applications.

Human-originated lead is responsible for increases the lead concentration found in water, which has resulted in the deaths of many water birds and aquatic organisms. Due to concerns about such lead poisoning, most lead-based fishing sinkers have been outlawed in the U.K., Canada, some U.S. states and all U.S. National Parks are now 100% lead-free zones.

Since the disfavor of lead sinkers, steel and brass have been marketed as substitutes, although fisherpersons have not widely adopted them due to their additional bulk and cost over lead. A material introduced more recently, tungsten, is now in considerable use, especially among Largemouth Bass fiserpersons. Although several times costlier than lead, fisherpersons tend to view tungsten as desirable since it is denser than lead and thus provides equivalent weight at around half of the bulk of lead. The environmental effects of tungsten within water bodies, however, are essentially unknown, a concern that has naturally arisen due to the inevitability of losing sinkers, irrespective of the material, during routine fishing.

The most common type of sinkers are made of lead so that the hook can reach the desired depth. However, recent research shows that lead, in fact, pollutes the water and all the flora and fauna that resides nearby.

Years of fishing, using sinkers made of lead, has created concern over the rising levels of lead found in aquatic plants and animals. This happens as the metal absorbed in a living organism does not get excreted with its waste, rather, this heavy metal accumulates in the body of the organism. Consequently, laws have been crafted to outlaw the use of lead as sinkers designed to be jettisoned. Ecologically savvy sportspersons have looked at alternative ways to making a hook reach a desired depth. Some have tried using different materials such as bismuth alloys, brass and tungsten, but all these were not able to achieve the desired results. The shapes of the sinker have been studied, shapes such as bullets and pyramids have been used but to very minimal utility. In short, there has been no sinker that has achieved greater depths without employing lead or other heavy metals in the design.

It is now critical that we need to find alternative materials or technology to achieve the purpose for which lead is being used without harming the environment as lead does.

Using the hydrodynamic pressure created by a dive plane makes the present invention, made of steel and cement, reach depths that until now only lead has achieved. A compound of Portland cement and granules of steel has been developed and employed to supplant the use of lead in sinkers. Although the specific gravity of this compound is less than that of lead, the diving force in combination with the compound equals the sinking ability of lead.

Uncharacteristic of historically used cannonball sinker weights, which use gravity alone to drag bait or lures down, the shape of the degradable diving sinker is critical. Using hydrodynamics compensates for what the degradable diving sinker lacks in gravity or density. The hydrodynamic shape, in combination with the steel and cement compound, creates a hybrid sinker using both a weighty material and dive angle to cause the sinker to present the fish bait at appropriate depths.

The combination of the above qualities and using degradable materials makes the sinker both compact and non-toxic, a significant improvement over present designs. The groove in which the release rests is cast at such an angle as to help maintain a stable and unwavering descent of the sinker.

The product being applied for a patent uses degradable steel granules and Portland cement cast in a cold process into a particular shape. The materials and technology, when put together in the proper manner, can create a degradable sinker that can equal the utility of its lead predecessors.

Since Portland cement and steel are both non-toxic to the environment, a mixture of these materials can be designed to fall apart by the rusting of steel. Over time, this causes the matrix of cement aggregate to crumble and turn to dust in a marine environment.

1. I claim a degradable diving sinker for trolling lures or bait to catch fish.

2. I claim (as in claim 1.) a sinker made of steel shavings recycled from the waste of the automobile brake and rotor resurfacing process, mixed with Portland cemant.

3. I claim (as in claim 2.) a sinker that is designed to be jetisoned from the fishing line when the fish tugs the bait, but can by retrieved and reused if the fish does not strike.

4. I claim (as in claim 3.) a degradable diving sinker utilizing a granular form of steel shavings that results from the brake and rotor resurfacing process, that is of a multiplicity of sizes (screens) producing a superior concrete.

5. I claim (as in claim 4.) the use of the steel byproduct of the brake and rotor resurfacing process as as an agregate in the concrete that is used to cast the degradable diving sinker.
